(19) United States
(12) Patent Application Publication
(10) Pub. No.: US 2025/0207558 A1
(43) Pub. Date: Jun. 26, 2025

(54) Adjustable-Length Horizontal Wind Turbine Blade With Thrust Force Transmission Structure

(71) Applicant: Morteza Keshavarzi Nigabadi, Isfahan (IR)

(72) Inventor: Morteza Keshavarzi Nigabadi, Isfahan (IR)

(21) Appl. No.: 19/037,421

(22) Filed: Jan. 27, 2025

Related U.S. Application Data
(63) Continuation-in-part of application No. PCT/IB2022/057103, filed on Jul. 30, 2022.

(30) Foreign Application Priority Data
Jul. 30, 2022 (WO) PCT/IB2022/057103

(51) Int. Cl. F03D 1/06

(52) U.S. Cl. CPC F03D 1/0677; F03D 1/0685; F05B 2240/302; F05B 2240/31

(57) ABSTRACT

A wind turbine with a retractable blade and a thrust force transmission structure provides an adjustable blade length system that maintains the airfoil shape and does not negatively impact aerodynamic efficiency. Thrust Force Transmission Structure that directly transfers the thrust forces from the blade tip to the hub, thereby reducing bending stresses and acting as a damper. This system significantly reduces the torque experienced at the root section, leading to a lighter blade design and extended blade lifespan.

### FIELD

The present disclosure relates to the rotor section of a wind turbine, and more specifically, to a retractable blade system with adjustable blade length based on wind speed, and a structure designed to transmit and reduce thrust forces acting on the blade.

### BACKGROUND

The present application builds upon patent No. WO2024028629A, filed on Jul. 30, 2022, which discloses a retractable blade system for wind turbines and a thrust force transmission structure. The invention described in the PCT application addresses the challenges of energy optimization in varying wind conditions and provides a system to manage thrust forces effectively. This disclosure introduces additional features and improvements, including improvement in method for retracting and extending the blade and further refinements to the thrust force transmission system. These enhancements improve the functionality, structural integrity, and overall performance of the wind turbine blade system.

Wind turbines with fixed blade lengths face significant challenges in optimizing energy generation across varying wind speeds. In low wind speeds, the full potential of the blade is underutilized, while in high wind speeds, the tip speed limitation restricts power generation. Additionally, transportation and installation of large blades, especially those reaching lengths of 120 meters for offshore turbines and 100 meters for onshore turbines, are logistically difficult and costly.

Another critical issue with long blades is the thrust force, which acts parallel to the wind direction. This force causes significant bending at the blade's tip and generates high torque at the root section. To withstand these forces, the root must be heavily reinforced, which increases the overall blade weight and results in a suboptimal tip design. Moreover, wind-induced vibrations exacerbate fatigue stress, further reducing the blade's lifespan and structural integrity.

Retractable blades can be categorized into two types:
1. Tip-First Retractable Blades: These blades retract from the tip, allowing the entire blade length to contribute to energy production. The retractable portion is designed to fit within the fixed section when retracted (e.g., U.S. Pat. No. 2,713,393, US200302223868, US20030230230898, US20100158687, WO2009095758).
2. Root-First Retractable Blades: In this design, the root portion near the hub is fixed, and the retractable section extends from the root outward. The root does not contribute directly to energy production, and the tip accommodates the retracted portion.

In prior art related to retractable blades, efficiency is often compromised.

### SUMMERY

The present invention provides an adjustable blade length system that maintains the airfoil shape and does not negatively impact aerodynamic efficiency. The force transfer between the fixed and movable sections is designed to distribute stresses evenly across the surface of the fixed blade, enhancing structural integrity.

This disclosure also introduces a Thrust Force Transmission Structure that directly transfers the thrust forces from the blade tip to the hub, thereby reducing bending stresses and acting as a damper. This system significantly reduces the torque experienced at the root section, leading to a lighter blade design and extended blade lifespan.

The invention divides the blade into two sections, with one section capable of sliding inside the other to adjust the blade length. This modular design simplifies transportation and installation, particularly for large blades used in onshore and offshore wind turbines.

### BRIEF DESCRIPTION OF THE DRAWINGS

FIG. 1a is an isometric view of a horizontal wind turbine.

FIG. 1b is an isometric view of the adjustable blade with the thrust force transmission structure.

FIG. 1c shows the blade components separately.

FIG. 2 is a cross-sectional view of the blade, illustrating its internal structure.

FIG. 3a shows details of the movable section of the blade.

FIG. 3b illustrates the separable section of the blade.

FIG. 3c shows details of the clamp system.

FIGS. 4a and 4b illustrate two views of the force transfer method between the fixed and movable sections of the blade.

FIGS. 5a, 5b, 5c, 5d, and 5e show the steps of the blade retraction process.

FIG. 6 illustrates details of the wire rope system used in the blade.

FIG. 7 is a cross-sectional view of the blade with the thrust force transmission structure.

FIG. 8 illustrates the details of the thrust force transmission system.

### DETAIL DESCRIPTION

During operation, a wind turbine blade is subjected to multiple forces. These forces include thrust force, which acts parallel to the wind direction and constitutes the primary force the blade structure is designed to withstand. Additionally, the blade experiences tangential force, which contributes to the rotation of the blade and generates energy. Other forces acting on the blade include centrifugal force, gravitational (weight) force, and torsional force. While centrifugal, gravitational, and torsional forces are present, their effects are generally considered secondary in comparison to the dominant thrust and tangential forces.

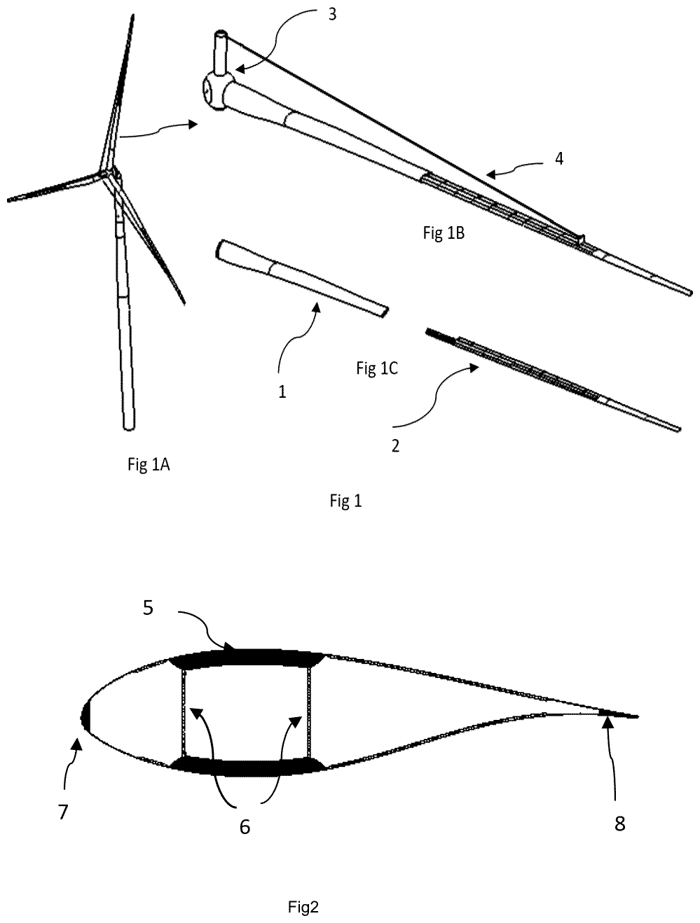

FIG. 1 illustrates the Adjustable-Length Blade with Thrust Force Transmission Structure. it comprises a fixed section of the blade 1 (as shown in FIG. 1C) and a movable section of the blade 2. The fixed section 1 is mounted to the hub 3 (as shown in FIG. 1B), while the movable section 2 is designed to retract or extend based on wind speed, thereby adjusting the length of the blade. A thrust force transmitter system 4 is attached to the movable section 2 and the hub 3 to transfer thrust force from the area near the tip of the blade to the hub 3.

FIG. 2 illustrates a cross-section of the wind turbine blade. The spar cap 5 and web shears 6 are responsible for withstanding and transferring thrust forces. The lead reinforcement 7 and tail reinforcement 8 are designed to transfer tangential forces to the previous section, which are then transmitted to the hub 3.

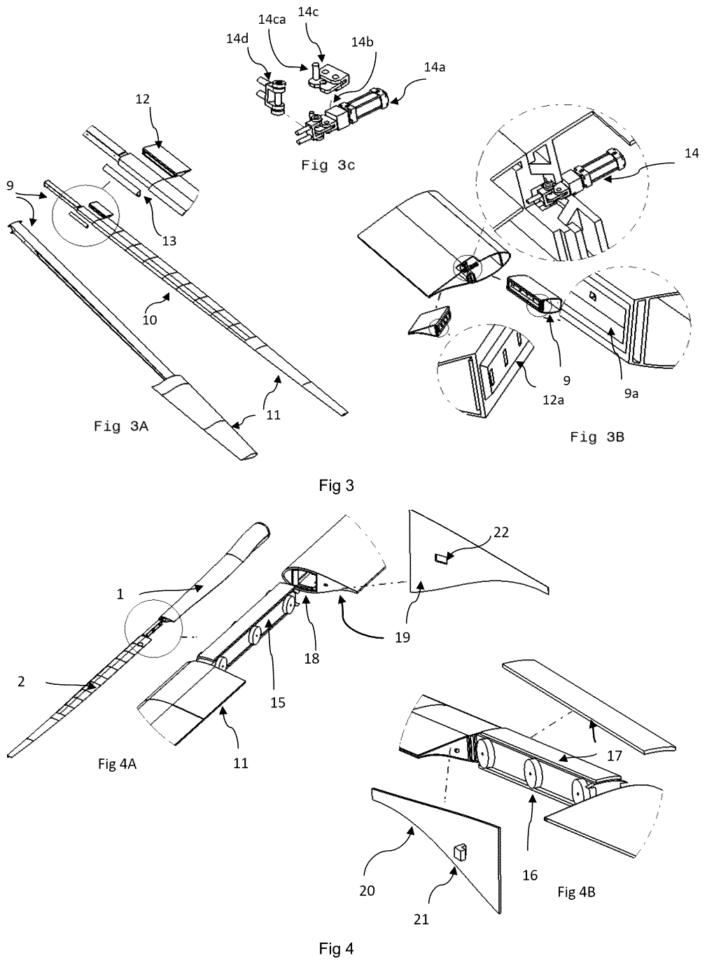

FIG. 3 illustrates the details of the movable section 2. The movable section includes a base 9 (as shown in FIG. 3A), which consists of the spar cap and web shears, at least one separable section 10, and a tip area 11. The tip area 11 is integrated with the base 9. The separable section 10 consists of a tail section 12, positioned between the web shear and the tail, and a lead section 13, positioned between the other web shear and the lead section. Both sections are attached to the base 9 by a clamp system 14 (as shown in FIG. 3B). The clamp system includes a pneumatic cylinder 14a (as shown in FIG. 3C), a cylinder lock 14b, a clamp 14c, and a gripper 14d. The pneumatic cylinder 14a secures the tail section 12 to the base 9. The male region 12a of the tail section 12 fits into the female region 9a of the base 9, securing the tail section 12 to the base. The cylinder lock 14b locks the piston of the pneumatic cylinder 14a in place. toggle lever 14ca is mounted to the one arm of clamp 14c.

One of the most challenging aspects of the retractable blade concept is the transfer of thrust and tangential forces from the movable section 2 to the fixed section 1 of the blade. A portion of the thrust force is transferred by the thrust force transmitter 4. FIG. 4 illustrates the force transfer mechanism. The first part of the movable section 15 (as shown in FIG. 4A) remains permanently inside the fixed section 1. This area is equipped with at least two wheels 16 to guide the movable part within the fixed section. (as shown in FIG. 4B). Additionally, at least two inflatable structures 17 are installed on both sides of section 15 to transfer thrust force to the fixed section 1. At least two further inflatable structures 18 are positioned at the front of the fixed section 1 to prevent the movable section 2 from colliding with the fixed section 1 during operation.

To transfer tangential forces, a plate 19 is embedded at the entrance of the fixed section in both the tail and lead areas. This plate 19 connects to the reinforced lead and tail sections of the fixed section 1. Additionally, the separable sections 11 of the tail 13 and lead areas 12 each have a corresponding plate 20. One side of the separable section's plate 20 includes a lock tab 21, while the opposite side contains a hole 22, enabling the plates to lock together. The nearest separable section's plate 20 locks with the fixed section's plate 19.

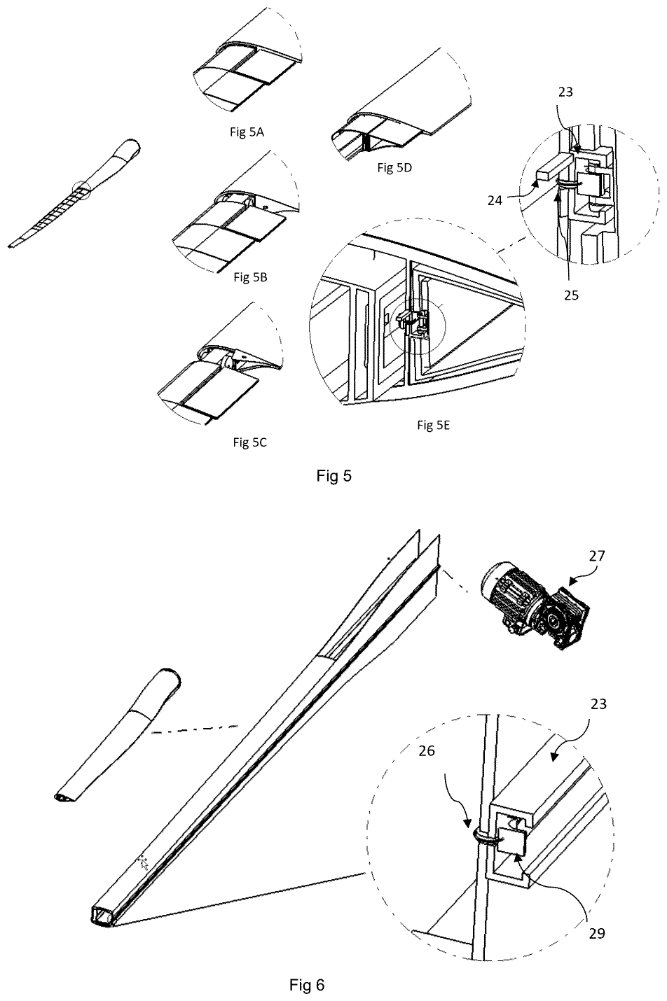

FIG. 5 illustrates the method of retracting and extending the blade. In the first step, the pneumatic cylinder lock 14b is released, and the pneumatic cylinder 14a is activated. The tail section 12 and lead section 13 of the separable part are moved away from the base 1 (as shown in FIG. 5A). This movement unlocks the fixed plate 19 and the next separable section 11. The movable section 2 then moves in the extension direction, increasing the blade's length to create space for the movement of the fixed plate 19, which is subsequently moved (as shown in FIG. 5B).

In the next step, plate 19 is opened (as shown in FIG. 5C) and the movable section 2 begins to move in the retraction direction, reducing the blade length. (as shown in FIG. 5D). One arm of the clamp system 14c is released when the toggle lever 14ca engages with the release lever 24 (as shown in FIG. 5E), which is installed on the web shear. Each arm of the clamp system 14c is equipped with gear teeth that engage with each other, causing the two arms to rotate in opposite directions. Once the gripper 14d is released, the pneumatic cylinder 14a pushes the clamp 14c back. The tail section 12 is guided into the space between the web shear and the tail of the fixed section 1 by a rail 23, where the wire rope system 25 is positioned

This process continues until the last gripper 14d is released. At this point, the movable section 2 stops, and the tail section 13 is moved by the wire rope system 25 until it is fully retracted into the designated section. the fixed plate 19 closes, and the next separable section 11 is moved away from the base 9. The movable part of the blade 2 resumes its movement until the two fixed plates come together, at which point they are locked in place by the movement of the tail section back to its original position. All of the mentioned processes occur simultaneously for the lead 12 and tail 13 sections.

FIG. 6 shows the wire rope system 25, which consists of a wire rope 26, a motor, and a gearbox 27. The motor and gearbox are positioned near the hub 3 and are connected to the web shear. A guide plate 29 is attached to the wire rope 26 and connects to the gripper 14d, allowing the system to move the gripper 14d in rail 23.

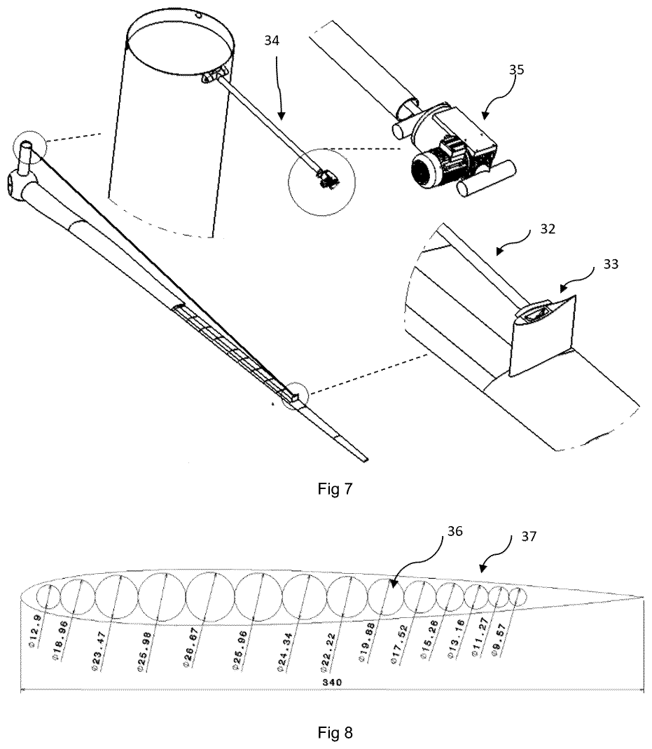

The purpose of the thrust force transmission structure 4 is to transfer thrust force from the tip area 11 to the hub 3. This transfer reduces the generation of excessive torque on the root section of the blade. FIG. 7 shows the details of the thrust force transmission structure 4. To achieve maximum performance, the thrust force transmission structure must maintain a clearance from the main blade, allowing the main blade to bend freely. The thrust force transmission blade 32 is installed on the thrust force transmission holder blade 33. A hydraulic system 34 is implemented to accommodate this flexibility. One side of the control mechanism 34 is mounted to the hub 3, while the other side is connected to the thrust force transmission pitch system 35. The angle of attack of the thrust force transmission blade 32 must be optimized to minimize its impact on the main blade, and the thrust force transmission pitch system 35 is used to maintain this alignment.

FIG. 8 illustrates a section of the thrust force transmission blade 32. To facilitate the transfer, an array of wire ropes 36 is used, which is covered with an airfoil 37 to minimize the impact on the blade's overall performance.

1. A wind turbine with a retractable blade and a thrust force transmission structure comprising:
a hub;
at least one fixed section of a blade mounted to said hub;
at least one movable section of the blade mounted to said fixed section of the blade, wherein said movable section of the blade moves inside the fixed section of the blade to increase or reduce the length of the blade; and
at least one thrust force transmission mounted between said movable section of the blade and said hub, configured to transfer a predetermined thrust force from the movable section of the blade to the hub.

2. The wind turbine of claim 1, wherein the fixed section of the blade comprises:
a blade mounted to said hub;
a polarity inflatable structure mounted in front of said blade, comprising means for preventing the movable section of the blade from crashing into said blade;
a guidance structure to guide said movable section of the blade during retraction and extension;
a guidance structure to guide said movable section of the blade during retraction and extension;
a tail section plate mounted to a tail region of said blade to transfer tangential force from said movable section of the blade to said blade; and
a lead section plate mounted to a lead region of said blade to transfer tangential force from said movable section of the blade to said blade.

3. The wind turbine of claim 2, wherein said lead and tail section plates of the fixed section of the blade are configured to move during retraction and extension of the movable section of the blade.

4. The wind turbine of claim 1, wherein the movable section of the blade comprises:
a base configured to transfer thrust force to said fixed section of the blade;
at least one separable section mounted to said base, wherein, in operation mode, said separable section is attached to the base, and in retraction mode, it is separated from the base;
a polarity inflatable structure installed on said base comprising means for distribute thrust force to said fixed section of the blade; and
polarity wheels mounted to said base to guide the base within said fixed section of the blade.

5. The wind turbine of claim 4, wherein the base of the movable section of the blade comprises:
an initial region located inside said fixed section of the blade, comprising means for transferring thrust force to said fixed section;
a region without airfoil shape, wherein said separable section is installed; and
a tip area that includes airfoil shape, which is positioned outside of said fixed section of the blade.

6. The wind turbine of claim 4, wherein said separable section comprises:
a lead section mounted to said base;
a tail section mounted to said base; and
a polarity clamp mechanism for securing the lead section and the tail section to the base.

7. The wind turbine of claim 6, wherein the lead section and the tail section comprise a locking mechanism configured to secure two adjacent lead and tail sections, along with their respective plates.

8. The wind turbine of claim 1, wherein said thrust force transmission structure comprises:
a holder blade mounted to said movable section of the blade;
a thrust force transmission blade mounted to said holder blade;
a pitch system configured to rotate said thrust force transmission blade to set a proper angle of attack;
a force transfer mechanism for transferring forces from said holder blade to said hub; and
a control mechanism for adjusting said force transfer structure to allow bending of the movable section of the blade and the fixed section of the blade.

9. The wind turbine of claim 1, wherein said thrust force transmission structure is also configured to be installed on an integrated blade.

10. A method of retracting and extending a retractable blade, comprising:
initiating retraction by moving a separable section away from the base;
moving the movable section of the blade in an extending direction, whereby the lead and tail section plates open;
starting the retraction of the movable section of the blade, whereby the clamp mechanism releases upon reaching the fixed section of the blade, allowing the movable section to move inside the fixed section of the blade;
closing the lead and tail section plates once all separable sections are positioned within the fixed section of the blade;
moving the separable section closest to the fixed section of the blade away from the base, and retracting the movable section until the separable section reaches the lead and tail section plates; and
moving the separable section toward the base, locking it together with the lead and tail section plates and the separable section.
